(19) United States
(12) Patent Application Publication
(10) Pub. No.: US 2026/0189290 A1
(43) Pub. Date: Jul. 2, 2026

(54) INDICATING CHANGES IN AN ANTENNA ARRAY CONFIGURATION IN AN ADJUSTABLE FORM FACTOR USER EQUIPMENT

(71) Applicant: QUALCOMM Incorporated, San Diego, CA (US)

(72) Inventors: Vasanthan RAGHAVAN, West Windsor Township, NJ (US); Jung Ho RYU, Englewood Cliffs, NJ (US); Junyi LI, Greentown, PA (US)

(21) Appl. No.: 19/003,881

(22) Filed: Dec. 27, 2024

(51) Int. Cl. H04B 7/06; H04W 52/08; H04W 52/14; H04W 52/36

(52) U.S. Cl. CPC H04B 7/06958; H04W 52/08; H04W 52/146; H04W 52/365; H04W 52/367

(57) ABSTRACT

A method for wireless communication at a user equipment (UE) includes identifying a change in an antenna array configuration of the UE based on a change in UE physical configuration from a first physical configuration to a second physical configuration. The method also includes transmitting, to a network node, a message based on detecting the change in the antenna array architecture, the message indicating the change in the antenna array configuration. The method further includes communicating with the network node via one or more communication channels based on transmitting the message, one or more characteristics of the one or more communication channels being adjusted based on the transmission of the message.

### INTRODUCTION

The present disclosure relates generally to wireless communications, and more specifically to an adjustable form factor user equipment (UE).

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In some aspects of the present disclosure, a method for wireless communication at a user equipment (UE) includes identifying a change in an antenna array configuration of the UE based on a change in the UE's physical configuration from a first physical configuration to a second physical configuration. The method also includes transmitting, to a network node, a message indicating the change in the antenna array configuration. The method further includes communicating with the network node via one or more communication channels, wherein one or more characteristics of the communication channels are adjusted based on the transmitted message.

Other aspects of the present disclosure are directed to an apparatus. The apparatus includes means for identifying a change in an antenna array configuration of the UE based on a change in the UE's physical configuration from a first physical configuration to a second physical configuration. The apparatus further includes means for transmitting, to a network node, a message indicating the change in the antenna array configuration. The apparatus also includes means for communicating with the network node via one or more communication channels, wherein one or more characteristics of the communication channels are adjusted based on the transmitted message.

In other aspects of the present disclosure, a non-transitory computer-readable medium with program code recorded thereon is disclosed. The program code is executed by one or more processors and includes program code to identify a change in an antenna array configuration of the UE based on a change in the UE's physical configuration from a first physical configuration to a second physical configuration. The program code further includes program code to transmit, to a network node, a message indicating the change in the antenna array configuration. The program code also includes program code to communicate with the network node via one or more communication channels, wherein one or more characteristics of the communication channels are adjusted based on the transmitted message.

Other aspects of the present disclosure are directed to an apparatus for wireless communication at a UE. The apparatus includes one or more processors and one or more memories coupled with the one or more processors, storing processor-executable code that, when executed by the one or more processors, is configured to cause the apparatus to identify a change in an antenna array configuration of the UE based on a change in the UE's physical configuration from a first physical configuration to a second physical configuration. Execution of the processor-executable code further causes the apparatus to transmit, to a network node, a message indicating the change in the antenna array configuration. Execution of the processor-executable code also causes the apparatus to communicate with the network node via one or more communication channels, wherein one or more characteristics of the communication channels are adjusted based on the transmitted message.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIGS. 4, 5, and 6 illustrate examples of an adjustable form factor UE, in accordance with various aspects of the present disclosure.

FIG. 7 is a timing diagram illustrating an example of dynamically adjusting one or more characteristics of one or more communication channels based on a change in an antenna array configuration of an adjustable form factor UE, in accordance with various aspects of the present disclosure.

FIG. 8 is a diagram illustrating an example of a wireless communications system that supports beamforming adaptation for adjustable form factors wireless devices, in accordance with aspects of the present disclosure.

FIG. 9 is a flow diagram illustrating an example process for dynamically adjusting one or more characteristics of one or more communication channels based on a change in an antenna array configuration of an adjustable form factor UE, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

A user equipment (UE) may feature an adjustable form factor, including, but not limited to, foldable, bendable, rollable, twistable, or other flexible configurations. These adjustable form factors enable the UE's physical structure (e.g., form factor configuration) to dynamically change during use. Most UEs feature non-adjustable displays due to form factor and cost considerations, though advancements in technology and design complexities have led to the increasing adoption of adjustable form factors. However, such adjustable form factor UEs introduce new challenges in wireless communication. For example, changes in the physical configuration of the UE can alter a shape and/or size of one or more antenna array configurations at the UE. These changes may necessitate beam refinement at the UE and/or a corresponding network node to maintain reliable communications between the UE and the network node. Additionally, such changes may also impact power control operations at the UE, thereby specifying adjustments to a maximum UE transmission power and/or related parameters.

A wireless device, such as a UE, may include multiple antenna modules, each comprising multiple antenna arrays designed to support communications with other wireless devices (e.g., at least one network node). These antenna arrays include a set of antenna elements that can be individually or jointly configured to transmit or receive wireless signals. Respective antenna arrays may be distributed across various locations or portions of the UE. The dynamic placement of these antenna arrays is particularly useful for UEs with adjustable form factors, as it allows the UEs to adapt to changing geometric configurations. Current wireless communication standards do not fully support such dynamic antenna configurations. Further developments in wireless communication standards may accommodate dynamic antenna configurations.

An antenna array is a system composed of multiple antennas arranged and configured to work together to transmit or receive signals to communicate with another wireless device, such as a network node. Each antenna array includes a group of antenna elements. These antenna elements may operate independently or in coordination, enabling the antenna array to focus energy in a specific direction during transmission or to capture energy from a specific direction during reception. Antenna arrays may be arranged in specific geometric patterns, including, but not limited to, linear, planar, or circular configurations. Other non-uniform placements or configurations may also be possible. Additionally, antenna arrays are scalable, with an addition of antenna elements increasing gain, directivity, reduced beamwidths, and overall device performance.

In some examples, an adjustable form factor UE may include a linear antenna array integrated within a rolling display unit. A size and configuration of the antenna array may be dynamically adjusted based on the state of the display. For example, as the rolling display unit is expanded (e.g., rolled out), the antenna array may change in size to accommodate the new form factor. In one such example, the antenna array may transition from a 4×1 configuration (e.g., four antenna elements arranged in a single linear row), to an 8×1 configuration (e.g., eight antenna elements arranged in a single linear row), to a 12×1 configuration (e.g., twelve antenna elements arranged in a single linear row). In some other examples, an adjustable form factor UE may change from a linear physical configuration (e.g., a “brick” form) to a non-linear physical configuration, such as, but not limited to, a V-shape form, a folded form, or a circular form. Correspondingly, the antenna array may change from a linear to a non-linear configuration. Communication characteristics used for transmission and reception of signals via one or more antenna arrays (or a portion of the one or more antenna arrays) may depend on a size and/or shape of the one or more antenna arrays.

In some examples, an adjustable form factor UE, such as a tri-fold device, may transition between different physical configurations, such as a mobile device state and a tablet state, with corresponding changes to the UE's antenna array architecture. In the mobile device state, the UE may form a planar array with collocated antennas. Based on the one or more antenna arrays being collocated, an overall antenna planar array of four (4) antenna elements by three (3) antenna elements (4×3) may be configured. When transitioning to the tablet state, the antenna arrays may reconfigure into a distributed layout (e.g., 4×1 linear antenna array). These changes in the UE's physical configuration impact various communication characteristics, such as, beamwidth, maximum transmission power, and/or a number of MIMO layers supported by the UE.

Additionally, or alternatively, the adjustable form factor UE may change in size. For example, the adjustable form factor UE may be a rolling UE or a flexible rolling UE. Based on this rolling example, an antenna array may remain linear, but the antenna array may change in size and with a corresponding number of active antenna elements based on the state of rolling. Specifically, when the physical configuration of the adjustable form factor UE is reduced, some antenna elements may overlap or recline behind others from the previous configuration. In this case, the overlapping antenna elements may enter an inactive mode. For example, the adjustable form factor UE may deactivate antenna elements that move behind others as the form factor changes, optimizing the antenna configuration for the current physical state. Accordingly, the different number of active antenna elements in the antenna array may impact various communication characteristics, including, but not limited to, the beamwidth, maximum transmission power, and the number of MIMO layers supported by the adjustable form factor UE.

In some cases, a UE may identify a change in an antenna array configuration of the UE in accordance with the UE changing from a first physical configuration to a second physical configuration. Each physical configuration corresponds to a respective form factor and a number of active mode antenna elements. That is, each physical configuration may be associated with a different antenna array architecture (e.g., configuration and/or positioning of antenna arrays). Changes in the antenna array architecture may affect the beamwidth of the antenna arrays, which directly impacts the number of reference signals (RSs) specified for effective network coverage. These adjustments influence various operations such as beam failure recovery, hand blockage mitigation, and on-demand beam refinement. Additionally, changes to the antenna array architecture may affect power control operations, particularly for uplink transmissions. For example, based on changes to the antenna array architecture, the UE may dynamically adjust power control parameters, such as maximum transmission power and closed-loop power control.

Various aspects of the present disclosure address challenges that arise when a UE has a dynamically adjustable form factor. The dynamically adjustable form factor may impact wireless communication, particularly in frequency range 2 (FR2) and frequency range 3 (FR3) bands. In some examples, based on detecting a change in UE physical configuration (e.g., from a first physical configuration to a second physical configuration), which corresponds to a change in the antenna array architecture, the UE may transmit a message indicating the change in the antenna array configuration to a network node. This indication can be explicit (e.g., directly signaling the change) or implicit (e.g., inferred from related updates). This indication may enable the UE and/or the network node to adapt to the new configuration by optimizing beamforming, reallocating reference signals, initiating an on-demand beam refinement procedure, and/or adjusting power control parameters, as needed. In some examples, the message may request on-demand beam training. In such examples, the on-demand beam training may improve link budget by leveraging increased array dimensions, tolerating greater link margin losses, and/or reducing a modulation and coding scheme (MCS) while maintaining a same error probability due to enhanced array gain. Additionally, or alternatively, the message may indicate a change to one or more parameters associated with a power control operation at the UE. The one or more parameters may include, for example, a power headroom (PHR), a maximum transmission power, a maximum power reduction (MPR), or a closed loop power control factor. Additionally, or alternatively, the message may indicate a change in a number of active antenna modules, a change in a number of active antenna panels, and/or a change in a number of multiple-input multiple-output (MIMO) layers supported by the UE. Additionally, or alternatively, message transmitted may indicate an update to a number of reference signals specified for beam failure recovery or beam refinement. The number of reference signals is based on the beamwidth, which is associated with the antenna array configuration. Additionally, or alternatively, the message may indicate the change to the beamwidth. The UE may communicate with the network node via one or more communication channels. For communications that occur after the transmission of the message, one or more characteristics of the one or more communication channels may be adjusted based on the UE transmitting the message (e.g., indicating the change in the antenna array configuration).

Particular aspects of the subject matter described in this disclosure can be implemented to realize one or more improvements. In some examples, the described techniques, such as identifying the change in the antenna array configuration and indicating the change in the antenna array configuration, may enable adaptive optimization of one or more communication channel characteristics. Such adaptive optimization maintains reliable signal quality and optimizes power management, even as the UE transitions between different physical configurations.

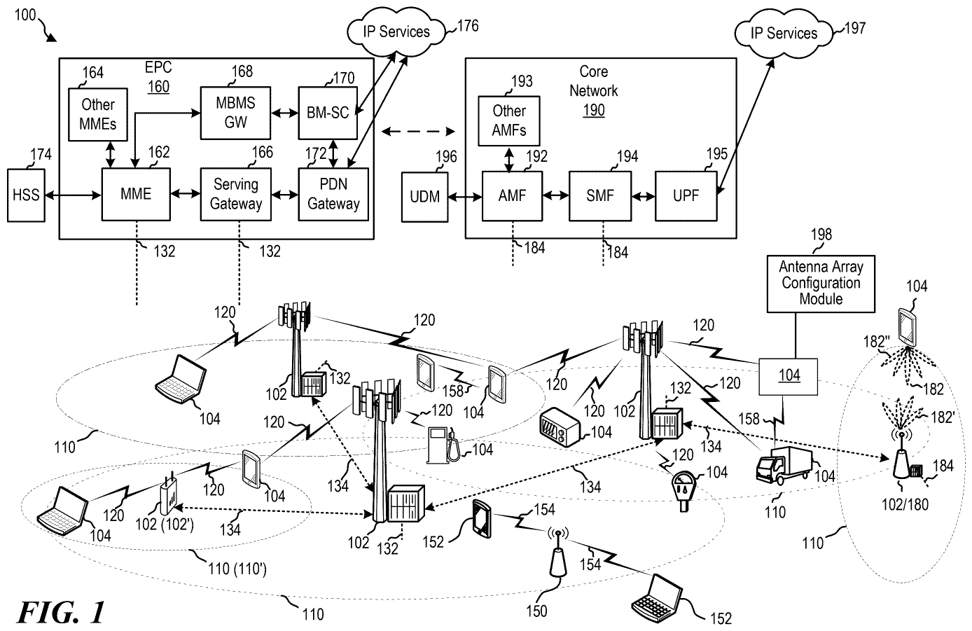

FIG. 1 is a diagram illustrating an example of a wireless communications system and an access network 100. The wireless communications system (also referred to as a wireless wide area network (WWAN)) includes base stations 102, UEs 104, an evolved packet core (EPC) 160, and another core network 190 (e.g., a 5G core (5GC)). The base stations 102 may include macrocells (high power cellular base station) and/or small cells 102′ (low power cellular base station). The macrocells include base stations. The small cells 102′ include femtocells, picocells, and microcells.

The base stations 102 configured for 4G LTE (collectively referred to as evolved universal mobile telecommunications system (UMTS) terrestrial radio access network (E-UTRAN)) may interface with the EPC 160 through backhaul links 132 (e.g., S1 interface). The base stations 102 configured for 5G NR (collectively referred to as next generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communications coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include home evolved Node Bs (eNBs) (HeNBs), which may provide service to a restricted group known as a closed subscriber group (CSG). The communications links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communications links 120 may use multiple-input and multiple-output (MIMO) antenna technology, including spatial multiplexing, beamforming, and/or transmit diversity. The communications links may be through one or more carriers. The base stations 102/UEs 104 may use spectrum up to Y MHz (e.g., 5, 10, 15, 20, 100, 400, etc., MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communications link 158. The D2D communications link 158 may use the DL/UL WWAN spectrum. The D2D communications link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communications may be through a variety of wireless D2D communications systems, such as FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communications links 154 in a 5 gigahertz (GHz) unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmWave may extend down to a frequency of 3 GHz with a wavelength of 100 millimeters. The super high frequency (SHF) band extends between 3 GHz and 30 GHz, also referred to as centimeter wave. Communications using the mmWave/near mm Wave radio frequency band (e.g., 3 GHZ-300 GHz) has extremely high path loss and a short range. The mmWave base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a mobility management entity (MME) 162, other MMEs 164, a serving gateway 166, a multimedia broadcast multicast service (MBMS) gateway 168, a broadcast multicast service center (BM-SC) 170, and a packet data network (PDN) gateway 172. The MME 162 may be in communication with a home subscriber server (HSS) 174. The MME 162 is the control node that processes the signaling between the UEs 104 and the EPC 160. Generally, the MME 162 provides bearer and connection management. All user Internet protocol (IP) packets are transferred through the serving gateway 166, which itself is connected to the PDN gateway 172. The PDN gateway 172 provides UE IP address allocation as well as other functions. The PDN gateway 172 and the BM-SC 170 are connected to the IP services 176. The IP services 176 may include the Internet, an intranet, an IP multimedia subsystem (IMS), a PS streaming service, and/or other IP services. The BM-SC 170 may provide functions for MBMS user service provisioning and delivery. The BM-SC 170 may serve as an entry point for content provider MBMS transmission, may be used to authorize and initiate MBMS bearer services within a public land mobile network (PLMN), and may be used to schedule MBMS transmissions. The MBMS gateway 168 may be used to distribute MBMS traffic to the base stations 102 belonging to a multicast broadcast single frequency network (MBSFN) area broadcasting a particular service, and may be responsible for session management (start/stop) and for collecting evolved MBMS (eMBMS) related charging information.

The core network 190 may include an access and mobility management function (AMF) 192, other AMFs 193, a session management function (SMF) 194, and a user plane function (UPF) 195. The AMF 192 may be in communication with a unified data management (UDM) 196. The AMF 192 is the control node that processes the signaling between the UEs 104 and the core network 190. Generally, the AMF 192 provides quality of service (QoS) flow and session management. All user Internet protocol (IP) packets are transferred through the UPF 195. The UPF 195 provides UE IP address allocation as well as other functions. The UPF 195 is connected to the IP services 197. The IP services 197 may include the Internet, an intranet, an IP multimedia subsystem (IMS), a PS streaming service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as Internet of Things (IoT) devices (e.g., a parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

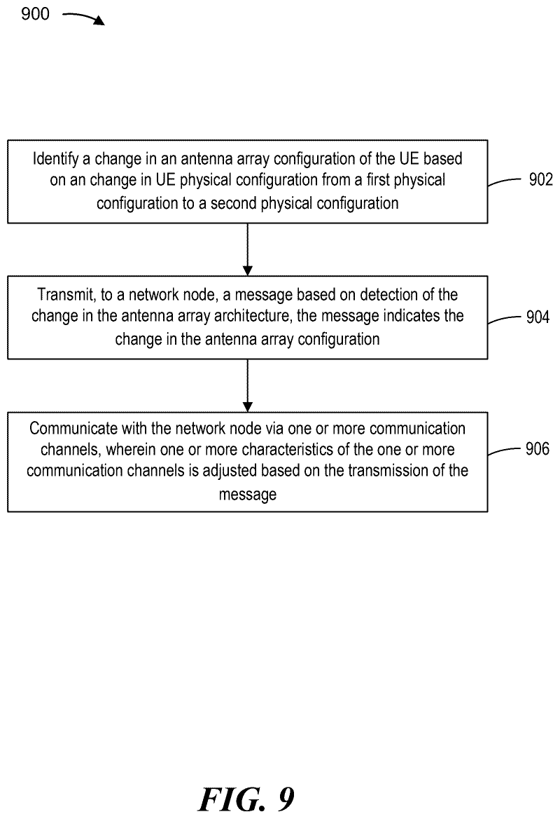

Referring again to FIG. 1, in certain aspects, a receiving device, such as the UE 104, may receive sensing information from one or more other UEs 104. The UE 104 that received the sensing information may also obtain sensing information from its own measurements. The UE 104 may include an antenna array configuration module 198. For brevity, only one UE 104 is shown as including the antenna array configuration module 198. The antenna array configuration module 198 may perform one or more operations, such as one or more operations of a process 900 described with reference to FIG. 9.

In some aspects, the network 100 may operate over a shared channel, which may include shared frequency bands and/or unlicensed frequency bands. For example, the network 100 may be an NR-U network operating over an unlicensed frequency band. In such an aspect, the BSs 102 and the UEs 104 may be operated by multiple network operating entities. To avoid collisions, the BSs 102 and the UEs 104 may employ a listen-before-talk (LBT) procedure to monitor for transmission opportunities (TXOPs) in the shared channel. A TXOP may also be referred to as COT. For example, a transmitting node (e.g., a BS 102 or a UE 104) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT4 LBT may be referred to as a Type1 LBT, where the LBT is performed independently on the carrier(s) on which a transmission is occurring or going to occur. Under Type2 LBT, one carrier can be selected to have a CAT4 LBT performed, and a single interval LBT (Type2 LBT) can be performed on other carriers, which may be performed before a scheduled start time that is indicated by the UL grants. As an example, a transmitting node may determine a channel measurement in a time interval and determine whether the channel is available or not based on a comparison of the channel measurement against an ED threshold.

Although the following description may be focused on 5G NR, it may be applicable to other similar areas, such as LTE, LTE-A, CDMA, GSM, and other wireless technologies, such as 6G and beyond.

As indicated above, FIG. 1 is provided merely as an example. Other examples may differ from what is described with regard to FIG. 1.

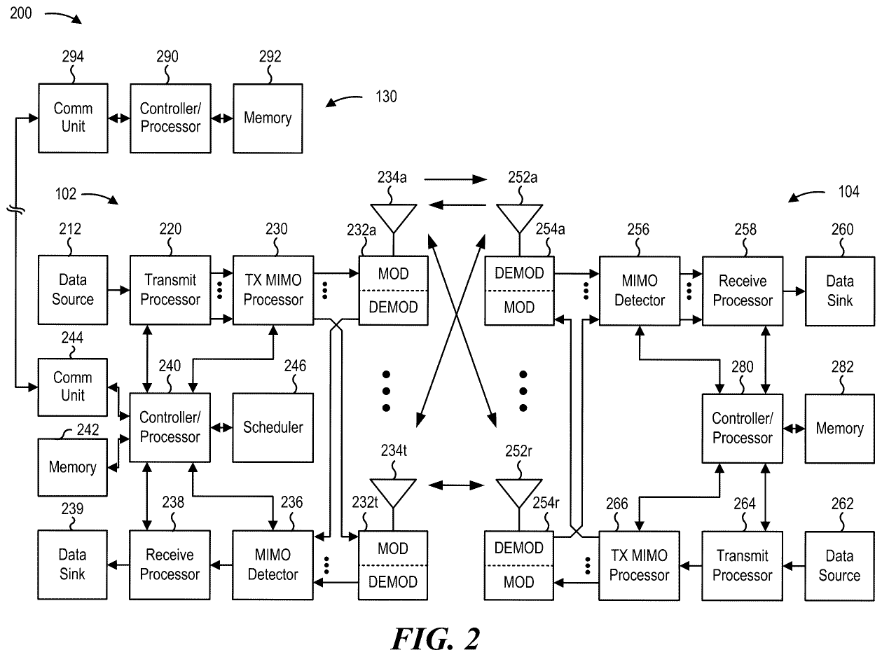

FIG. 2 shows a block diagram of a design 200 of the base station 102 and UE 104, which may be one of the base stations and one of the UEs in FIG. 1. The base station 102 may be equipped with T antennas 234a through 234t, and UE 104 may be equipped with R antennas 252a through 252r, where in general T≥1 and R≥1.

At the base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 104, antennas 252a through 252r may receive the downlink signals from the base station 102 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 104 may be included in a housing.

On the uplink, at the UE 104, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 102. At the base station 102, the uplink signals from the UE 104 and other UEs may be received by the antennas 234, processed by the demodulators 254, detected by a MIMO detector 236 if applicable, and further processed by a receive processor 238 to obtain decoded data and control information sent by the UE 104. The receive processor 238 may provide the decoded data to a data sink 239 and the decoded control information to a controller/processor 240. The base station 102 may include communications unit 244 and communicate to the core network 130 via the communications unit 244. The core network 130 may include a communications unit 294, a controller/processor 290, and a memory 292.

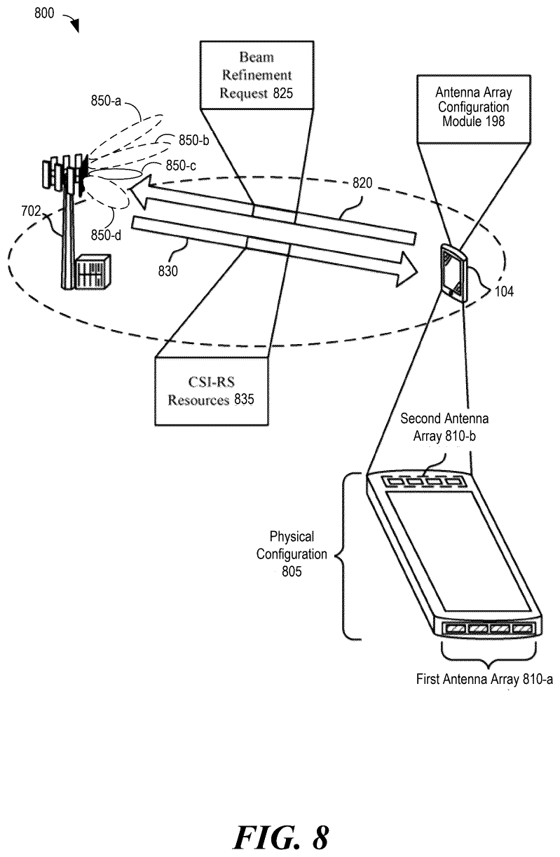

The controller/processor 240 of the base station 102, the controller/processor 280 of the UE 104, and/or any other component(s) of FIG. 2 may perform one or more techniques associated with dynamically adjusting one or more characteristics of one or more communication channels based on a change in an antenna array configuration of an adjustable form factor UE, as described in more detail elsewhere. For example, the controller/processor 240 of the base station 102, the controller/processor 280 of the UE 104, and/or any other component(s) of FIG. 2 may perform or direct operations of, for example, the process of FIG. 8 and/or other processes as described. Memories 242 and 282 may store data and program codes for the base station 102 and UE 104, respectively. A scheduler 246 may schedule UEs for data transmission on the downlink and/or uplink.

In some aspects, the UE 104 and/or base station 102 may include means for identifying a change in an antenna array configuration of the UE based on the UE changing from a first physical configuration to a second physical configuration; means for transmitting, to a network node, a message based on detecting the change in the antenna array architecture, the message indicating the change in the antenna array configuration; and c means for communicating with the network node via one or more communication channels based on transmitting the message, one or more characteristics of the one or more communication channels having been adjusted based on the transmission of the message. Such means may include one or more components of the UE 104 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

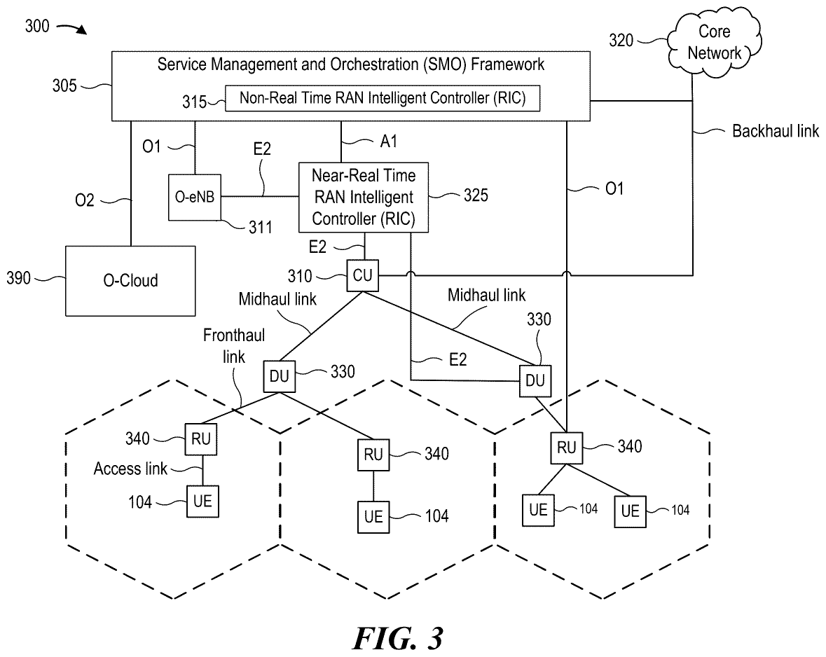

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

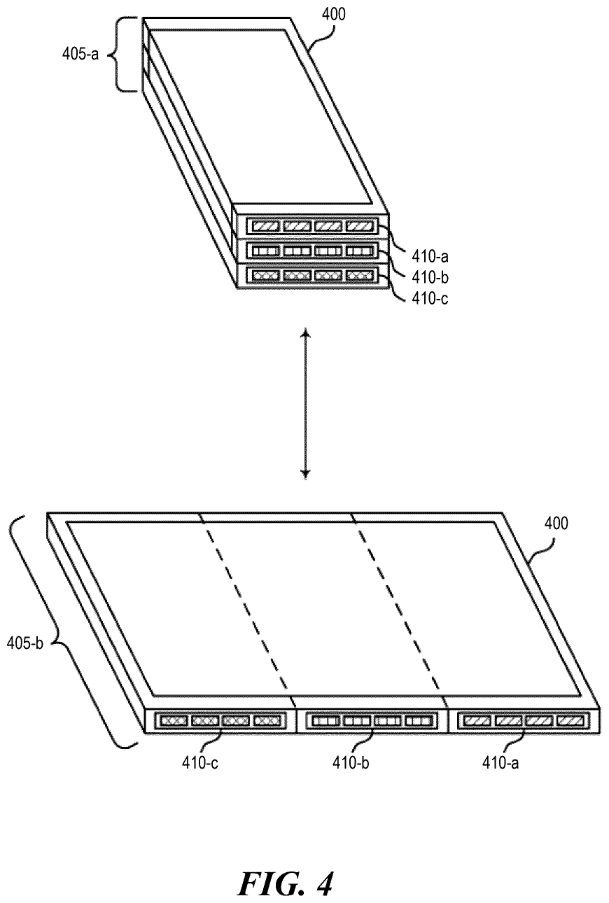

As discussed, various aspects of the present disclosure are directed to adjustable form factor UEs (e.g., foldable and multi-foldable devices), which have gained commercial prominence as original equipment manufacturers (OEMs) compete to introduce new or advanced features. Additionally, as shown in the examples of FIGS. 4, 5, and 6, an antenna array in the adjustable form factor UE may change a size and/or shape (e.g., linear to non-linear) based on changes to the physical configuration of the adjustable form factor UE. Current wireless communication standards do not fully support such dynamic antenna configurations. Further developments in wireless communication standards may accommodate dynamic antenna configurations.

A physical configuration refers to the specific structural state of a UE that determines its form factor, size, and the arrangement or positioning of its components, such as one or more antenna arrays. Each physical configuration is associated with a respective form factor (e.g., mobile device state, tablet state, folded form, circular form) and a corresponding antenna array architecture. The physical configuration directly impacts the antenna array architecture, which includes the size, shape, configuration, and/or positioning of the antenna arrays, as well as a number of active antenna elements.

Changes in the physical configuration, such as transitioning from a compact to an expanded state, may result in adjustments to communication characteristics, including beamwidth, maximum transmission power, and the number of multiple-input multiple-output (MIMO) layers supported by the UE. Additionally, these changes influence various network operations, such as beam failure recovery, hand blockage mitigation, on-demand beam refinement, and uplink power control. For example, as the physical configuration transitions, antenna elements may become inactive (e.g., recline or overlap) or active, and the UE may dynamically adjust parameters such as power control settings or reference signal allocations to optimize performance based on the new physical configuration.

As discussed, a change in the configuration or positioning of antenna modules results in adjustments to a beamwidth of the antenna array. A change in the beamwidth directly affects the number of reference signals (RSs) required for coverage, which, in turn, impacts critical network operations such as beam failure recovery, hand blockage mitigation, and on-demand beam refinement. For instance, a narrower beamwidth may specify fewer reference signals but demands higher precision for beam alignment, while a broader beamwidth may need additional reference signals for comprehensive coverage. Additionally, changes in antenna module configurations influence power control operations, particularly in the uplink context. As the antenna panels aggregate or reconfigure, the UE may need to adjust parameters, such as a maximum transmission power and closed-loop power control factors, to optimize communications.

Various aspects of the present disclosure address challenges that arise when a UE has a dynamically adjustable form factor, which impacts wireless communication, particularly in frequency range 2 (FR2) and frequency range 3 (FR3) bands. FR2 covers frequencies from 24.25 GHz and beyond, while FR3 spans 7.125 GHz to 24.25 GHz. In some implementations, upon detecting a change in its physical configuration, the adjustable form factor UE may transmit an indication of the change to a network node. This indication enables the UE and/or the network node to adapt to the new configuration by optimizing beamforming, reallocating reference signals, initiating an on-demand beam refinement procedure, and adjusting power control parameters, as needed.

FIG. 4 illustrates an example of an adjustable form factor UE 400, in accordance with various aspects of the present disclosure. The adjustable form factor 400 may be a UE 104 as described with reference to FIGS. 1-3. In particular, the adjustable form factor UE 400 in FIG. 4 is an example of a tri-folding flexible UE.

As shown in the example of FIG. 4, the adjustable form factor UE 400 may include a first physical configuration associated with a mobile device state 405-a. In the mobile device state 405-a, three antenna arrays 410 may be formed into a planar array with collocated antennas. For example, a first antenna array 410-a may be located on a first fold, a second antenna array 410-b may be located on a second fold, and a third antenna array 410-c on a third fold of the adjustable form factor UE 400. Based on the antenna arrays 410 being collocated, an overall antenna planar array of four (4) antenna elements by three (3) antenna elements may be configured. Additionally, as shown in FIG. 4, the adjustable form factor UE 400 may include a second physical configuration that corresponds to a tablet state 405-b, where the three antenna arrays 410 are changed to a distributed array of three linear antenna arrays of four (4) antennas by one (1) antenna. Accordingly, based on its tri-fold capability, the adjustable form factor UE 400 of FIG. 4 may change both an effective array shape and size of antennas based on a given physical configuration (e.g., planar and collocated for the mobile device state 405-a to linear and distributed for tablet state 405-b). In some cases, the adjustable form factor UE 400 may assume that the antenna elements are placed in the mobile device state 405-a as a default, and the antenna elements are transformed to the placement for the tablet state 405-b. The changes to the configuration of antenna arrays 410, as illustrated in FIG. 4, impact various communication characteristics, including, but not limited to, the beamwidth, maximum transmission power, and the number of MIMO layers supported by the adjustable form factor UE 400.

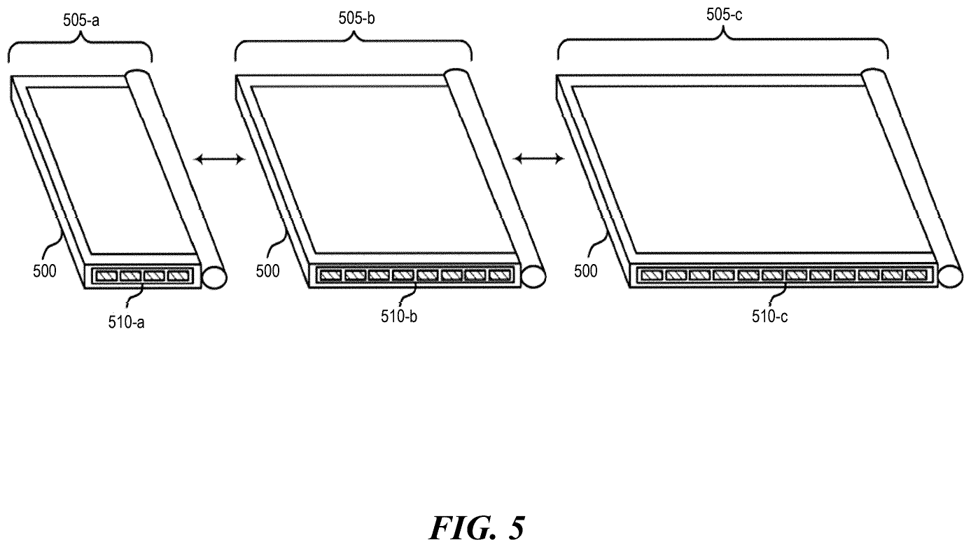

FIG. 5 illustrates an example of an adjustable form factor UE 500, in accordance with various aspects of the present disclosure. The adjustable form factor UE 500 may be a UE 104 as described with reference to FIGS. 1-3. In particular, the adjustable form factor UE 500 in FIG. 5 is an example of a rolling UE or a flexible rolling UE.

As shown in the example of FIG. 5, the adjustable form factor UE 500 may include multiple physical configurations 505-a, 505-b, and 505-c that correspond to different form factors and a number of active mode antenna elements. In the example of FIG. 5, the physical configuration of the adjustable form factor UE 500 may be reduced from a third physical configuration 505-c to a first physical configuration 505-a. As the physical configuration and corresponding form factor are reduced, the antenna elements may overlap from a previous physical configuration, such as a second physical configuration 505-b, and recline into or behind existing antenna elements for the current physical configuration, such as the first physical configuration 505-a. Based on the overlapping antenna elements, the antenna elements that recline into or behind the existing antenna elements may enter an inactive mode. For example, the adjustable form factor UE 500 may be internally configured to deactivate an antenna element when it moves behind another antenna element.

Initially, the adjustable form factor UE 500 may assume that its antenna elements are placed according to a third antenna array 510-c for the corresponding third physical configuration 505-c, where the third physical configuration 505-c is a tablet form factor. For example, the third antenna array 510-c may include a linear array of twelve (12) antenna elements by one (1) antenna element. The adjustable form factor UE 500 may then roll down to the second physical configuration 505-b that includes a second antenna array 510-b, where the second physical configuration 505-b corresponds to an intermediate state of rolling. The second physical configuration 505-b may include a number of antenna elements in the second antenna array 510-b that is less than the number of antenna elements in the third antenna array 510-c. For example, the second antenna array 510-b may include a linear array of eight (8) antenna elements by one (1) antenna element. The adjustable form factor UE 500 may further be rolled down to the first physical configuration 505-a that includes a first antenna array 510-a, where the first physical configuration 505-a corresponds to a mobile form factor for the adjustable form factor UE 500. The first physical configuration 505-a may include a number of antenna elements in the first antenna array 510-a that is less than the number of antenna elements in both the third antenna array 510-c and the second antenna array 510-b. For example, the first antenna array 510-a may include a linear array of four (4) antenna elements by one (1) antenna element.

Based on this rolling example, an antenna array 510 may remain linear, but the antenna array 510 may change in size and with a corresponding number of active antenna elements based on the state of rolling. Accordingly, the different number of active antenna elements in the antenna array 510 may impact various communication characteristics, including, but not limited to, the beamwidth, maximum transmission power, and the number of MIMO layers supported by the adjustable form factor UE 500.

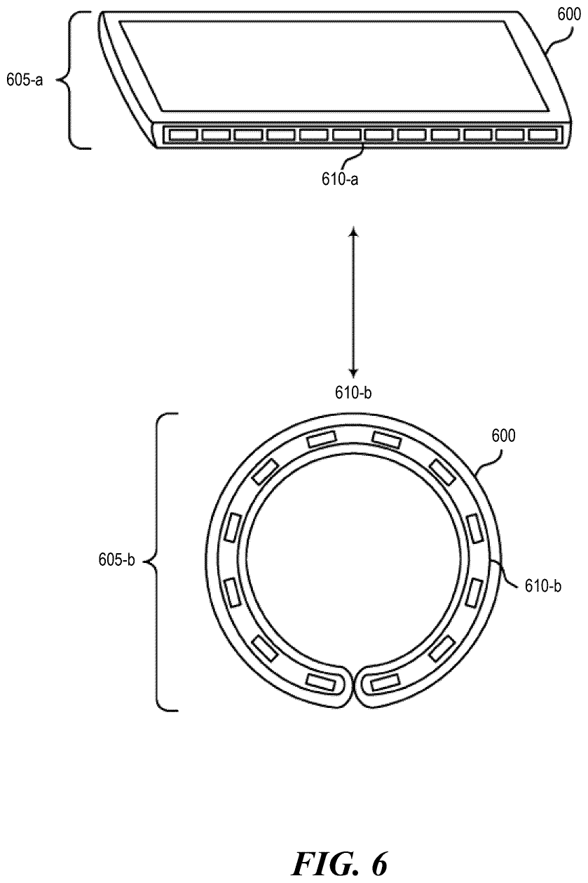

FIG. 6 illustrates an example of an adjustable form factor UE 600, in accordance with various aspects of the present disclosure. The adjustable form factor UE 600 may be a UE 104 as described with reference to FIGS. 1-3. In particular, the adjustable form factor UE 600 in FIG. 6 is an example of a wearable UE or a flexible UE (e.g., such as a watch).

As shown in the example of FIG. 6, the adjustable form factor UE 600 may include different physical configurations 605 corresponding to different form factors and an antenna array 610. For example, the adjustable form factor UE 600 may initially assume that antenna elements are placed according to a first physical configuration 605-a and a first antenna array 610-a, where the first physical configuration 605-a is a mobile form factor. As shown, the first antenna array 610-a may include a linear array of twelve (12) antenna elements by one (1) antenna element. The adjustable form factor UE 600 may then be rolled up to a wearable shape as indicated by a second physical configuration 605-b. The second physical configuration 605-b may include the same number of antenna elements in a second antenna array 610-b as the first antenna array 610-a. However, the second antenna array 610-b may be circular or have a different shape, orientation, etc., compared to the first antenna array 610-a for the first physical configuration 605-a. The transformation of a linear array of antenna elements to a non-linear array of antenna elements may impact various communication characteristics, including, but not limited to, the beamwidth, maximum transmission power, and the number of MIMO layers supported by the adjustable form factor UE 600.

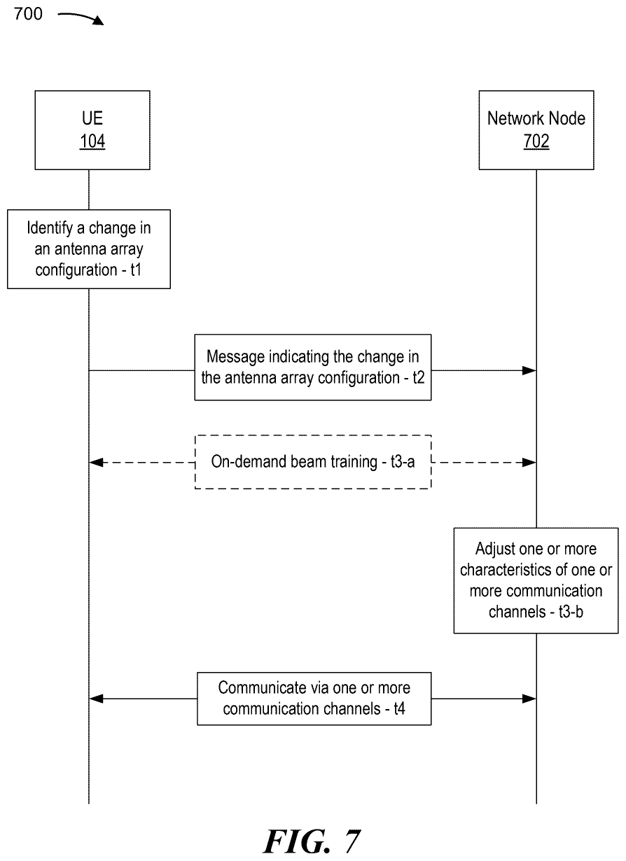

FIG. 7 is a timing diagram illustrating an example 700 of dynamically adjusting one or more characteristics of one or more communication channels based on a change in an antenna array configuration of an adjustable form factor UE, in accordance with various aspects of the present disclosure. As shown in the example 700 of FIG. 7, a UE 104 may communicate with a network node 702. The network node 702 may be an example of a base station 102, as described with reference to FIGS. 1-2, or a CU 310, DU 330, or RU 340 as described with reference to FIG. 3. The UE 104 may be an example of an adjustable form factor UE 400, 500, or 600 as described with reference to FIGS. 4-6, respectively. Aspects of the present disclosure are not limited to the adjustable form factor UEs 400, 500, or 600, other types of adjustable form factor UEs are contemplated.

As shown in the example 700 of FIG. 7, at time t1, the UE 104 identifies a change in an antenna array configuration of the UE 104 based on the UE 104 changing from a first physical configuration to a second physical configuration. The changes between physical configurations may involve transitions between different states, such as foldability, rollability, or multi-foldable configurations. The UE 104 detects the change from the first physical configuration to the second physical configuration via one or more internal sensors that monitor how current distribution flows across different feed points in the circuitry. For example, changes in current flow or distribution may indicate when the UE 104 shifts from one physical configuration to another, such as moving from a folded state to an unfolded state. This detection mechanism may be supported by antenna tuners and other sensing equipment that enable the UE 104 to determine and respond to these physical configuration changes.

The change in the physical configuration corresponds to a change in an antenna array configuration. For example, the UE 104 may change from a 4×1 antenna array (four antenna elements in a linear arrangement) to an 8×1 array. As another example, the UE 104 may transition from a 12×1 linear array to a 12×1 circular array, which introduces changes to beam properties. For example, a beamwidth and beam patterns of a 4×1 linear array may differ from those of a 12×1 linear array, while a 12×1 linear array is entirely distinct from a 12×1 circular array in terms of beam patterns.

As shown in the example 700 of FIG. 7, at time t2, the UE 104 transmits, to the network node 702, a message based on detecting the change in the antenna array architecture. The message indicates the change in the antenna array configuration. The indication may be an explicit indication or an implicit indication.

In the explicit approach, the UE 104 may transmit a message indicating the specific change, such as transitioning from a 12×1 linear array to a 12×1 circular array. This explicit information allows the network node 702 to adjust parameters, such as, for example, a number of reference signals based on predefined rules or calculations. For example, if the network node 702 knows the UE 104 transitioned from a smaller linear array to a larger linear array, the network node 702 may calculate an approximate number of reference signals needed to cover the new configuration's coverage area.

In the implicit approach, the UE 104 may not explicitly indicate a change in antenna panel configuration but instead provide related signaling updates, such as adjustments to power control parameters or beamforming characteristics. For example, the UE 104 may request a beam training procedure. As another example, the UE 104 may indicate a change to a maximum UE transmission power and/or a change to a power headroom. The implicit approach allows the network node 702 to respond to the needs of the UE 104 without detailed knowledge of the specific antenna array configuration, simplifying the signaling protocol.

In some examples, the message transmitted at time t2 indicates an update to a number of reference signals specified for beam failure recovery or beam refinement. The number of reference signals is based on the beamwidth, which is associated with the antenna array configuration. Alternatively, the message may indicate the change to the beamwidth.

The beamwidth determines the number of beams specified to cover a given coverage region. Specifically, Ω represents a coverage region in steradians and B is the beamwidth of an individual beam in steradians. The total number of beams specified to cover the region is given by Ω/B. This relationship implies that as the beamwidth B decreases (narrower beams), more beams are needed to cover the same coverage region Ω. Conversely, wider beams (larger B) reduce the number of beams but may compromise precision in directional communication.

The beamwidth is approximately inversely proportional to the number of antenna elements in the array, expressed as

$$beamwidth \approx \frac{100}{N} degrees ,$$

where N represents a number of antenna elements. For example, a four-element linear antenna array produces a beamwidth of approximately 25 degrees. To cover a range of ±50 degrees, the UE 104 would need approximately four reference signals. As another example, a twelve-element linear array may produce a narrower beamwidth (100/12), specifying twelve signals.

The number of reference signals is not strictly proportional to the number of antenna elements. The number of reference signals may also depend on the specific coverage criteria. For example, if the UE 104 needs to scan a narrow region, such as ±15 degrees, a single reference signal or a maximum of two reference signals may suffice. The UE 104 dynamically determines an appropriate number of reference signals for tasks such as beam failure recovery or beam refinement based on its configuration and use case.

The beamwidth of an antenna array directly affects how much area is covered by a single beam and, consequently, how many beams and reference signals are specified to maintain reliable communications. Without precise information about changes in beamwidth, the network node 702 cannot allocate a sufficient number of reference signals.

Changes in beamwidth also impact other network operations, such as timing adjustments. If the UE 104 does not provide explicit information about beamwidth changes or associated timing delays, the network node 702 indirectly infers beamwidth changes or associated timing delays. These inferences involve back-calculations based on the number of reference signals requested and an estimate of the beamwidth change. Such an approach introduces additional computational overhead at the network node 702, reducing network efficiency. Beamwidth changes may also impact positioning accuracy.

Additionally, or alternatively, in some examples, the message transmitted at time t2 requests on-demand beam training. The on-demand beam training request is an event-driven request, driven by changes in the antenna array configuration, which corresponds to a change in the physical configuration of the UE 104. As an example, when transitioning from a smaller antenna array to a larger antenna array, the array gain increases while the beamwidth decreases. This occurs because the total energy in the beam pattern, such as a discrete Fourier transform (DFT) beam, remains constant. As the beamwidth narrows, the energy becomes more concentrated, resulting in higher peak gain. Conversely, when the array size decreases, the peak gain reduces, and the beamwidth broadens.

As the form factor of a device changes, larger antenna arrays may improve array gain, but more beams may be specified to identify the optimal beam for communication. Narrower beamwidths, while offering improved gain, are more susceptible to mobility-induced losses, necessitating refinement and continuous tracking to maintain the connection. To address this, the UE 104 may request an on-demand beam training procedure to adapt to changes in the antenna array dimensions. This process improves the link budget by leveraging the increased array dimensions, tolerating greater link margin losses, and potentially reducing a modulation and coding scheme (MCS) while maintaining a same error probability due to enhanced array gain.

In some examples, in response to changes to the antenna array configuration, the UE 104 requests on-demand beam training because an optimal beam for the new array configuration is not predetermined. In response to the on-demand beam training, the UE 104 and/or the network node 702 may initiate the on-demand beam training at time t3-a. This on-demand beam training performed at time t3-a may involve performing a P2 beam refinement procedure (e.g., network node-side beam refinement), a P3 beam refinement procedure (UE-side beam refinement), or a joint P2 and P3 beam refinement procedure, where both the network node 702 and the UE 104 collaborate to identify the best beams at both ends. In the joint refinement procedure, the UE 104 aligns with the optimal beam for the new antenna configuration while allowing the network node 702 to simultaneously refine a transmit beam for improved communication.

During the P2 beam refinement procedure, the network node 702 refines its transmit beam by narrowing the beamwidth and adjusting the beam direction to maximize the signal strength received by the UE 104. An example of narrowing the beamwidth and/or adjusting the beam direction is described with respect to the beams 850-a, 850-b, 850-c, and 850-d. Specifically, the P2 beam refinement procedure involves the network node 702 transmitting a sequence of directional beams while the UE 104 provides feedback on the quality of each beam (not shown in the example of FIG. 7), enabling the network node to fine-tune its transmission.

In the P3 beam refinement procedure, the UE 104 refines its receive beam by aligning its antenna array to capture a strongest possible signal from the network node 702. This process involves the UE 104 scanning for incoming signals from different directions and adjusting its receive beam to optimize signal quality. In a joint P2 and P3 beam refinement procedure, the UE 104 and the network node 702 perform simultaneous refinements of their respective beams. The UE 104 may adjusts its receive beam while the network node 702 refines its transmit beam, with feedback exchanged between the two devices 702 and 104. This collaborative approach allows both the network node 702 and the UE 104 to dynamically adapt to the change in the antenna array architecture.

Additionally, or alternatively, in some examples, the message transmitted at time t2 may indicate updates to one or more power control parameters. The one or more power control parameters may include, for example, a power headroom report (PHR), a maximum UE transmission power, or a power control loop factor. In wireless communication systems, such as NR systems, power control operations are governed by a feedback loop to optimize uplink transmission power. The uplink transmission power (P_{PUSCH}(i)) is determined based on the following equations:

$${P}_{PUSCH} ( i ) = min \{ {P}_{CMAX} , 10 {log}_{10} ( {M}_{PUSCH} ( i ) ) + {P}_{{0}_{PUSCH}} ( j ) + α ( j ) \cdot PL + {Δ}_{TF} ( i ) + f ( i ) \} [ dBm ] \qquad ( 1 )$$

In Equation 1, P_{CMAX} represents the UE's maximum transmission power, which defines a highest power the UE 104 can transmit. P_{CMAX} is determined by the architecture of the UE 104 (the device's declared power class) including power amplifiers (PAs) and the configuration of the UE's antenna arrays. 10 log₁₀ (M_{PUSCH}(i)) represents power scaling based on a number of resource blocks M_{PUSCH} allocated for uplink transmissions. P₀_{_{PUSCH}}(j) represents an open-loop power control parameter, setting a baseline transmission power level. Additionally, α represents an optimization parameter between 0 and 1. α(j) may be set low for high interference settings, and α(j) may be set high to fully compensate for path loss. PL is the path loss between the UE 104 and the network node 702. Path loss captures loss in beamforming gain due to propagation over freespace. Propagation loss is a function of carrier frequency. For example, under line-of-sight (LOS) conditions with a path loss exponent (PLE) of two, transmissions at 71 GHz experience approximately 1.9 dB more loss compared to transmissions at 57 GHz. When the PLE increases to three, the difference in propagation loss rises to approximately 2.9 dB. Additionally, array gain is also influenced by the carrier frequency, given that the inter-antenna element spacing in the antenna array remains fixed. At higher frequencies, the same physical spacing translates to a greater number of antenna elements per wavelength, which impacts the achievable array gain. In Equation 1, Δ_{TF}(i) represents a transmission format adjustment based on the modulation and coding scheme. Finally, f(i) represents a closed-loop power control factor, which adjusts the uplink transmission power based on feedback from the network node 702 (e.g., power control commands).

In systems where each antenna element is paired with an individual power amplifier (PA), the power per element is determined by the PA's maximum output. For example, if the UE 104 operates with a 4×1 array (four antenna elements) and each PA supports 20 decibel-milliwatts (dBm), the total array power is 26 dBm. If the UE 104 transitions to a 12×1 array (twelve antenna elements) with the same PA configuration, the total array power increases due to the gain provided by additional elements. Specifically, the array gain increases by approximately 10 log₁₀(N2/N1), where N1 and N2 represent the number of elements in the old and new antenna array configurations, respectively. For example, changing from a 4×1 to a 12×1 antenna array increases the gain by approximately 4.7 decibels (dB), resulting in a total array power of approximately 30.7 dBm. This change effectively transitions the device to a higher power class, which should be reported to the network node 702 to maintain proper power control operations.

Alternatively, in architectures where a single PA is shared across multiple antenna elements, such as a PA driving three elements in a retractable array, the power per element decreases as the array size increases. In this case, the maximum UE transmission power (P_{CMAX}) remains constant even as the array configuration changes. For example, a shared 20 dBm PA across three elements maintains the same maximum UE transmission power of 26 dBm but redistributes the power among the elements. These architectural differences underscore the need for the UE 104 to indicate its power configuration to the network node 702 when the UE 104 changes from one physical configuration to another physical configuration.

When the UE 104 transitions between antenna array configurations, one or more aspects of the power control loop may be adjusted. In some examples, the maximum UE transmission power (P_{CMAX}) may be adjusted. Specifically, if the change in antenna array configuration affects a total antenna array gain, the UE 104 may report an updated maximum UE transmission power (P_{CMAX}) to the network node 702, such that the network node 702 understands the UE's transmission capabilities and can adjust the power control loop accordingly.

Additionally, or alternatively, the UE 104 may update the closed-loop power control factor. As the number of antenna elements changes, the granularity of closed-loop power control steps may be refined to provide precise power adjustments. For example, smaller steps may be specified to maintain optimal performance with increased beamforming gain. Additionally, or alternatively, the UE 104 may update power headroom reporting. The power headroom represents a difference between the maximum power the UE 104 can transmit (e.g., P_{CMAX}) and the actual power used for uplink transmission. In dynamic configurations, power headroom can fluctuate significantly, and under certain conditions, the power headroom may even become negative. Negative power headroom occurs when the UE's scheduled power for a transmission exceeds the available maximum UE transmission power (P_{CMAX}), often due to mismatches between array configurations and the timing of power allocation. For example, transitioning from a 12×1 antenna array to a 4×1 antenna array reduces antenna array gain, leading to less power required for a given beamforming task, which may improve power headroom. Conversely, moving from a 4×1 antenna array to a 12×1 antenna array increases antenna array gain, potentially resulting in negative power headroom if the allocated power exceeds the adjusted maximum UE transmission power (P_{CMAX}). The transmission power may correspond to the transmission power of an actual PUSCH or a virtual PUSCH, where the latter is configured with default parameters, such as the number of resource blocks (RBs), path loss reference signals (PL RSs), and other settings.

Additionally, or alternatively, in some examples, the message, transmitted at time t2, may indicate an update to the number of supported MIMO layers as a result of adjustments to the antenna array (e.g., panel) configuration. Specifically, when the form factor of the UE 104 changes, such as transitioning from a linear antenna array configuration to a circular antenna configuration, the number of MIMO layers that can be supported may also change. For example, with a 12×1 antenna array, the UE 104 may use a two-layer transmission. However, when transitioning to a configuration where the antenna array splits into two sets of six elements each, the UE 104 may instead use two layers per set, effectively altering the MIMO configuration.

In some examples, the message transmitted at time t2 may be a UE assistance information (UAI) message. The changes to the physical configuration (e.g., form factor) of the UE 104 are not expected to occur frequently, as such, the message transmitted at time t2 may include a validity period for these updates. For example, the updated configuration may apply for a specified time period, such as 20 milliseconds, several minutes, or longer, depending on the UE's operating mode. For example, if the UE 104 is in a tablet mode, this configuration may persist for a few minutes, whereas if the transition to tablet mode is brief (e.g., five seconds), the UE 104 may revert to its mobile form factor configuration. Additionally, or alternatively, in some examples, the message transmitted at time t2 may indicate a change in a number of active antenna modules or a change in a number of active antenna panels.

In the example 700 of FIG. 7, at time t3-b, the network node 702 may adjust one or more characteristics of one or more communication channels based on the message received at time t2. Additionally, or alternatively, the network node 702 may initiate or participate in beam training if the message requests on-demand beam training. At time t4, the network node 702 may communicate with the UE 104 via one or more communication channels based on transmitting the message at time t2. The one or more communication channels may include, for example, a PUSCH, physical uplink control channel (PUCCH), physical downlink shared channel (PDSCH), and/or physical downlink control channel (PDCCH). One or more characteristics of the one or more communication channels may be adjusted based on the transmission of the message at time t2. For example, the one or more characteristics may include one or both of an uplink beam refined in accordance with the on-demand beam training or a downlink beam refined in accordance with the on-demand beam training. Additionally, or alternatively, one characteristic of the one or more characteristics is an uplink transmission power. Additionally, or alternatively, one characteristic of the one or more characteristics is the quantity of MIMO layers.

FIG. 8 is a diagram illustrating an example of a wireless communications system 800 that supports beamforming adaptation for adjustable form factors wireless devices, in accordance with aspects of the present disclosure. As shown in the example of FIG. 8, the wireless communications system 800 may include a network node 702 and a UE 104. The UE 104 may be an example of an adjustable form factor UE 400, 500, or 600 as described with reference to FIGS. 4-6, respectively. Aspects of the present disclosure are not limited to the adjustable form factor UEs 400, 500, or 600, other types of adjustable form factor UEs are contemplated. In the example of FIG. 8, the UE.

As previously discussed, UE 104 may be referred to as an adjustable form factor UE, where the UE 104 includes different physical configurations, such as the different physical configurations described with respect to FIGS. 4-6, in addition to other types of physical configurations. For example, the different physical configurations may include flexible, bendable, or rollable form factors that the UE 104 uses for different functions (e.g., a mobile device, a phone, a tablet, or other devices with different form factors). Accordingly, the UE 104 may need to indicate an update to a number of reference signals specified for beam failure recovery or beam refinement based on a change to the UE physical configuration. The number of reference signals is based on the beamwidth, which is associated with the antenna array configuration. Additionally, or alternatively, the UE 104 may indicate a change to a beamwidth based on a change to the UE physical configuration.

As described above, the UE 104 may identify a specific physical configuration 805 (e.g., form factor) for itself that includes a first antenna array 810-a and a second antenna array 810-b located in different positions around the UE 104. For example, the first antenna array 810-a may illustrate an example of an antenna array position at the bottom of the UE 104. Additionally the second antenna array 810-b may illustrate an example of an antenna array placement on the front side of the UE 104. The different placements of the antenna arrays 810-a and 810-b may depend on a form factor of the UE 104, performance enhancements for the UE 104 (e.g., to minimize external interference by a user's hand), and/or other factors. While these two placements are shown in the example of FIG. 8, it is to be understood that the antenna arrays 810-a and 810-b may be placed at additional different positions around the UE 104 (e.g., front face, sides, etc.) or include additional or fewer antenna arrays.

In some examples, the UE 104 may feed information about the physical configuration 805 from sensors (e.g., potentiometers, gyros, etc.) to one or more processors and/or modules of the UE 104, such as the antenna array configuration module 198 described with reference to FIG. 1. Specifically, in one example, one or more sensors may indicate a change from one physical configuration to the physical configuration 805 shown in FIG. 8. Based on the change to the physical configuration 805, the antenna array configuration module 198 may transmit an uplink transmission 820 to the network node 702 that includes a beam refinement request 825. The beam refinement request 825 is an example of the message transmitted at time t2 in the example 700 described with reference to FIG. 7. In some examples, the beam refinement request 825 may indicate an update to a number of reference signals, such as CSI-RSs, specified for beam failure recovery or beam refinement based on a change to the UE physical configuration. The number of reference signals is based on the beamwidth, which is associated with the antenna array configuration. Based on beam refinement request 825, the network node 702 may transmit a downlink transmission 830 that includes one or more CSI-RS resources 835 as indicated in the request. The UE 104 may then perform a beam refinement procedure based on the received CSI-RS resources 835. Specifically, based on the measurements of the CSI-RS resources, one or more beams for subsequent communications with the network node 702 may be refined, such as narrowed or widened. For example, based on the measurements of the CSI-RS resources 835, the network node 702 may change a beam from an active narrow beam 850-c to a wide beam 850-d. Additionally, or alternatively, the network node 702 may alter a direction of a beam or selection one or more beams 850-a, 850-b, 850-c, or 850-d. For example, the beam direction may change from a direction associated with an active third beam 850-a to a direction associated with a first beam 850-a, a second beam 850-b, or a third beam 850-d. Additionally, or alternatively, the beam refinement request 825 may indicate a change to a beamwidth based on a change to the physical configuration 805. The beams 850-a, 850-b, 850-c, and 850-d illustrated in FIG. 8 are provided for illustrative purposes. The aspects of the present disclosure are not limited to these specific beams 850-a, 850-b, 850-c, and 850-d, their corresponding beamwidths, or their directions as shown in FIG. 8.

As indicated above, FIGS. 3-8 are provided as examples. Other examples may differ from what is described with respect to FIGS. 3-8.

FIG. 9 is a flow diagram illustrating an example process 900 for dynamically adjusting one or more characteristics of one or more communication channels based on a change in an antenna array configuration of an adjustable form factor UE, in accordance with various aspects of the present disclosure. The adjustable form factor UE is an example of a UE 104 described with reference to FIGS. 1-3 or an adjustable form factor UE 400, 500, or 600 described with reference to FIGS. 4-7. As shown in the example of FIG. 9, the example process 900 begins at block 902 by identifying a change in an antenna array configuration of the UE based on a change in UE physical configuration from a first physical configuration to a second physical configuration. At block 904, the process 900 transmits, to a network node, a message based on detecting the change in the antenna array architecture, the message indicating the change in the antenna array configuration. At block 906, the process 900 communicates with the network node via one or more communication channels based on transmitting the message, one or more characteristics of the one or more communication channels being adjusted based on the transmission of the message.

Implementation examples are described in the following numbered clauses:
Clause 1. A method for wireless communication at a UE, comprising: identifying a change in an antenna array configuration of the UE based on a change in UE physical configuration from a first physical configuration to a second physical configuration; transmitting, to a network node, a message based on detecting the change in the antenna array architecture, the message indicating the change in the antenna array configuration; and communicating with the network node via one or more communication channels based on transmitting the message, one or more characteristics of the one or more communication channels having been adjusted based on the transmission of the message.
Clause 2. The method of Clause 1, wherein: the message includes a request for on-demand beam training; the one or more characteristics include one or both of an uplink beam refined in accordance with the on-demand beam training or a downlink beam refined in accordance with the on-demand beam training; and the method further comprises performing one or both of a P2 or a P3 beam refinement procedure based on the request for the on-demand beam training.
Clause 3. The method of any one of Clauses 1-2, wherein the message indicates an update to a power headroom report (PHR).
Clause 4. The method of any one of Clauses 1-3, wherein: the message indicates one or both of an update to a maximum UE transmission power or an update to a closed loop power control factor; and one characteristic of the one or more characteristics is an uplink transmission power.
Clause 5. The method of any one of Clauses 1-4, wherein the first message indicates an update to a quantity of active antenna modules or panels, at the UE, corresponding to the change in the antenna array architecture.
Clause 6. The method of any one of Clauses 1-5, wherein: the first message indicates an update to a quantity of MIMO layers supported at the UE; and one characteristic of the one or more characteristics is the quantity of MIMO layers.
Clause 7. The method of any one of Clauses 1-6, wherein the first message is a UE assistance information (UAI) message.
Clause 8. The method of any one of Clauses 1-7, wherein the first message indicates an expected time period the UE will maintain the change in the antenna array architecture.
Clause 9. The method of any one of Clauses 1-8, wherein: the first physical configuration is associated with a linear antenna array architecture; and the second physical configuration is associated with a non-linear antenna array architecture.
Clause 10. The method of any one of Clauses 1-8, wherein: the first physical configuration is associated with a first linear antenna array architecture having a first array size; and the second physical configuration is associated with a second linear antenna array architecture having a second array size.
Clause 11. An apparatus comprising a processor, memory coupled with the processor, and instructions stored in the memory and operable, when executed by the processor to cause the apparatus to perform any one of Clauses 1-10.
Clause 12. An apparatus comprising at least one means for performing any one of Clauses 1-10.
Clause 13. A computer program comprising code for causing an apparatus to perform any one of Clauses 1-10.
Clause 14. A user equipment (UE), comprising: a processing system that includes processor circuitry and memory circuitry that stores code and is coupled with the processor circuitry, the processing system configured to cause the UE to perform any one of Clauses 1-10.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise. Additionally, the phrase “in accordance with” may encompass meanings such as “based on,” “associated with,” “using,” or “in response to,” all of which may be used interchangeable. The phrase reflects the relationship between the elements or actions being described.

What is claimed is:

1. An apparatus for wireless communication at a user equipment (UE), comprising:
one or more processors; and
one or more memories coupled with the one or more processors, the one or more processors configured to cause the UE to:
identify a change in an antenna array configuration of the UE based on a change in UE physical configuration from a first physical configuration to a second physical configuration;
transmit, to a network node, a message based on detection of the change in the antenna array architecture, the message indicates the change in the antenna array configuration; and
communicate with the network node via one or more communication channels, wherein one or more characteristics of the one or more communication channels is adjusted based on the transmission of the message.

2. The apparatus of claim 1, wherein:
the message includes a request for on-demand beam training;
the one or more characteristics include one or both of an uplink beam refined in accordance with the on-demand beam training or a downlink beam refined in accordance with the on-demand beam training; and wherein
the one or more processors are further configured to cause the UE to perform one or both of a P2 or a P3 beam refinement procedure based on the request for the on-demand beam training.

3. The apparatus of claim 1, wherein the message indicates an update to a power headroom report (PHR).

4. The apparatus of claim 1, wherein:
the message indicates one or both of an update to a maximum UE transmission power or an update to a closed loop power control factor; and
one characteristic of the one or more characteristics is an uplink transmission power.

5. The apparatus of claim 1, wherein the first message indicates an update to a quantity of active antenna modules or panels, at the UE, corresponding to the change in the antenna array architecture.

6. The apparatus of claim 1, wherein:
the first message indicates an update to a quantity of multiple-input multiple-output (MIMO) layers supported at the UE; and
one characteristic of the one or more characteristics is the quantity of MIMO layers.

7. The apparatus of claim 1, wherein the first message is a UE assistance information (UAI) message.

8. The apparatus of claim 1, wherein the first message indicates an expected time period the UE will maintain the change in the antenna array architecture.

9. The apparatus of claim 1, wherein:
the first physical configuration is associated with a linear antenna array architecture; and
the second physical configuration is associated with a non-linear antenna array architecture.

10. The apparatus of claim 1, wherein:
the first physical configuration is associated with a first linear antenna array architecture that has a first array size; and
the second physical configuration is associated with a second linear antenna array architecture that has a second array size.

11. A method for wireless communication at a user equipment (UE), comprising:
identifying a change in an antenna array configuration of the UE based on a change in UE physical configuration from a first physical configuration to a second physical configuration;
transmitting, to a network node, a message based on detecting the change in the antenna array architecture, the message indicating the change in the antenna array configuration; and
communicating with the network node via one or more communication channels based on transmitting the message, one or more characteristics of the one or more communication channels being adjusted based on the transmission of the message.

12. The method of claim 11, wherein:
the message includes a request for on-demand beam training;
the one or more characteristics include one or both of an uplink beam refined in accordance with the on-demand beam training or a downlink beam refined in accordance with the on-demand beam training; and
the method further comprises performing one or both of a P2 or a P3 beam refinement procedure based on the request for the on-demand beam training.

13. The method of claim 11, wherein the message indicates an update to a power headroom report (PHR).

14. The method of claim 11, wherein:
the message indicates one or both of an update to a maximum UE transmission power or an update to a closed loop power control factor; and
one characteristic of the one or more characteristics is an uplink transmission power.

15. The method of claim 11, wherein the first message indicates an update to a quantity of active antenna modules or panels, at the UE, corresponding to the change in the antenna array architecture.

16. The method of claim 11, wherein:
the first message indicates an update to a quantity of multiple-input multiple-output (MIMO) layers supported at the UE; and
one characteristic of the one or more characteristics is the quantity of MIMO layers.

17. The method of claim 11, wherein the first message is a UE assistance information (UAI) message.

18. The method of claim 11, wherein the first message indicates an expected time period the UE will maintain the change in the antenna array architecture.

19. The method of claim 11, wherein:
the first physical configuration is associated with a linear antenna array architecture; and
the second physical configuration is associated with a non-linear antenna array architecture.

20. The method of claim 11, wherein:
the first physical configuration is associated with a first linear antenna array architecture having a first array size; and
the second physical configuration is associated with a second linear antenna array architecture having a second array size.

21. A non-transitory computer-readable medium having program code recorded thereon for wireless communication at a user equipment (UE), the program code executed by one or more processors and comprising:
program code to identify a change in an antenna array configuration of the UE based on a change in UE physical configuration from a first physical configuration to a second physical configuration;
program code to transmit, to a network node, a message based on detection of the change in the antenna array architecture, the message indicates the change in the antenna array configuration; and
program code to communicate with the network node via one or more communication channels, wherein one or more characteristics of the one or more communication channels is adjusted based on the transmission of the message.

22. The non-transitory computer-readable medium of claim 21, wherein:
the message includes a request for on-demand beam training;
the one or more characteristics include one or both of an uplink beam refined in accordance with the on-demand beam training or a downlink beam refined in accordance with the on-demand beam training; and
the non-transitory computer-readable medium further comprises program code to cause the UE to perform one or both of a P2 or a P3 beam refinement procedure based on the request for the on-demand beam training.

23. The non-transitory computer-readable medium of claim 21, wherein the message indicates an update to a power headroom report (PHR).

24. The non-transitory computer-readable medium of claim 21, wherein:
the message indicates one or both of an update to a maximum UE transmission power or an update to a closed loop power control factor; and
one characteristic of the one or more characteristics is an uplink transmission power.

25. The non-transitory computer-readable medium of claim 21, wherein the first message indicates an update to a quantity of active antenna modules or panels, at the UE, corresponding to the change in the antenna array architecture.

26. The non-transitory computer-readable medium of claim 21, wherein:
the first message indicates an update to a quantity of multiple-input multiple-output (MIMO) layers supported at the UE; and
one characteristic of the one or more characteristics is the quantity of MIMO layers.

27. The non-transitory computer-readable medium of claim 21, wherein the first message is a UE assistance information (UAI) message.

28. The non-transitory computer-readable medium of claim 21, wherein the first message indicates an expected time period the UE will maintain the change in the antenna array architecture.

29. The non-transitory computer-readable medium of claim 21, wherein:
the first physical configuration is associated with a linear antenna array architecture; and
the second physical configuration is associated with a non-linear antenna array architecture.

30. The non-transitory computer-readable medium of claim 21, wherein:
the first physical configuration is associated with a first linear antenna array architecture having a first array size; and
the second physical configuration is associated with a second linear antenna array architecture having a second array size.
